(19) United States
(12) Patent Application Publication
(10) Pub. No.: US 2026/0106760 A1
(43) Pub. Date: Apr. 16, 2026

(54) SERVICE ACCOUNTS FOR AUTHENTICATION AND ACCESS CONTROL IN DISTRIBUTED COMPUTING SYSTEMS

(71) Applicant: Autodesk, Inc., San Francisco, CA (US)

(72) Inventors: Monmohan Singh, Singapore (SG); Yu Ke, Singapore (SG); Sanjeev Kumar Biswas, Ashfield (AU)

(21) Appl. No.: 18/917,278

(22) Filed: Oct. 16, 2024

(51) Int. Cl. H04L 9/32; G06F 21/62; H04L 9/08

(52) U.S. Cl. CPC H04L 9/3226; G06F 21/6218; H04L 9/0825; H04L 9/3213; G06F 2221/2141

(57) ABSTRACT

Methods, systems, and apparatus, including computer programs encoded on computer storage media, for using service accounts for authentication and access control in a distributed computing platform. A distributed computing platform having a plurality of computers configured to execute instructions implementing a plurality of software subsystems includes an identity management subsystem, one or more platform tools, and an application, wherein the identity management subsystem is configured to maintain user accounts for human users to access the one or more platform tools, and wherein the identity management subsystem is configured to maintain service accounts for non-human entities in the platform including assigning a service account to the application.

### BACKGROUND

This specification relates to distributed computer systems and distributed computer-aided design (CAD) systems.

Modern CAD systems provide sophisticated capabilities for designing and illustrating a wide variety of entities, including buildings, computer chips, and other products of manufacture. Such CAD systems increasingly provide compatibility with third-party applications that augment the capabilities of tools provided by the CAD systems. As one example, an architecture firm that designs buildings can use a CAD tool hosted by a distributed CAD system to design the floor plan of a building and then can use a third-party application that is specialized for generating cost estimates based on a particular building design.

But security concerns arise when granting a third-party application access to potentially sensitive company data. Some computing platforms control data access of third-party applications using API keys. An application can for example provide an API key to an authentication service on the platform to receive an access token, which then grants the application access to platform data.

However, API keys suffer from a number of drawbacks. First, they typically provide to an application all-or-nothing access to data of the account that authorized or installed the application. But doing so often provides an application with access to far more sensitive company data than is required for the application to perform its task. For example, an architecture firm may want to use a cost estimation application for a single project out of hundreds of projects in development on the platform. Providing the application access to all projects introduces risks of data leaks and the possibility of compromised data integrity.

Moreover, API keys are cumbersome to use because they typically require a human user to log in with a username and a password. This mechanism for API keys is therefore unsuitable for large-scale distributed systems that may use hundreds or thousands of computing nodes for particular computing tasks.

### SUMMARY

This specification describes how a distributed system can use service accounts for authentication and access control of non-human entities. In this specification, a non-human entity is an entity interacting with one or more software subsystems in a distributed computing system and without being directly controlled by a human user. Non-human entities thus can be physical or virtual machines, computing nodes, computing devices, containers, applications, or any other appropriate software subsystems.

For such non-human entities, a distributed computing platform can assign a service account. Service accounts allow non-human entities to interact with software subsystems of the distributed computing platform in the same way that user accounts for humans do. In other words, by using service accounts, the computing platform does not need to implement separate APIs for requests from non-human entities relative to human entities. Because of this transparent functionality, access control for service accounts can have the same level of precision and granularity as user accounts do.

But in contrast to traditional user accounts, service accounts can be initialized and authenticated using a different mechanism than for user accounts. For example, user accounts can continue using a username and password authentication mechanism. On the other hand, service accounts can be authenticated using messages signed with private keys. This makes initializing non-human entities that use service accounts highly scalable to hundreds or thousands of nodes without the need for tedious human logins.

Particular embodiments of the subject matter described in this specification can be implemented so as to realize one or more of the following advantages. Using service accounts as described in this specification enables applications to access data smoothly without recurring user interactions, while maintaining the same level of security and access control as regular user accounts. Service accounts offer flexibility to accommodate various application scenarios and integration patterns, thereby fostering the growth of the third-party application ecosystems. Service accounts also provide seamless identity management for non-human entities, e.g., machines, nodes, and devices, allowing them to be recognized as distinct entities within the system. This is achieved while adhering to best practices for identity management, access control, and data protection. Using service accounts also provides for easy integration with licensing and subscription management systems, enabling the assignment and enforcement of named-entity-based subscriptions and licenses for these entities.

The techniques described in this specification also provide service accounts with significantly higher security over approaches that utilize passwords. Passwords are not ideal because they require human interaction for standard authentication and have numerous vulnerabilities, such as susceptibility to brute force and dictionary attacks, in addition to the risk of reuse.

In contrast, utilizing asymmetric cryptography with Service accounts enhances governance by allowing only designated applications to authenticate and generate access tokens, improves auditability, supports secure key rotation, and aligns better with modern compliance requirements.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a diagram of an example system.

FIG. 2 is a diagram illustrating issuing an access token to an application having a service account.

FIG. 3 illustrates assigning an application-managed service account to an application.

FIG. 4 is a flowchart illustrating an account administrator installing a third-party application having a service account.

FIG. 5 illustrates a run-time example of an application having a service account accessing project data.

FIG. 6 illustrates creating customer-managed service accounts.

FIG. 7 illustrates attaching customer-managed service accounts to computing nodes.

FIG. 8 illustrates how service accounts can be used to manage licenses for non-human entities in a distributed computing platform.

Like reference numbers and designations in the various drawings indicate like elements.

### DETAILED DESCRIPTION

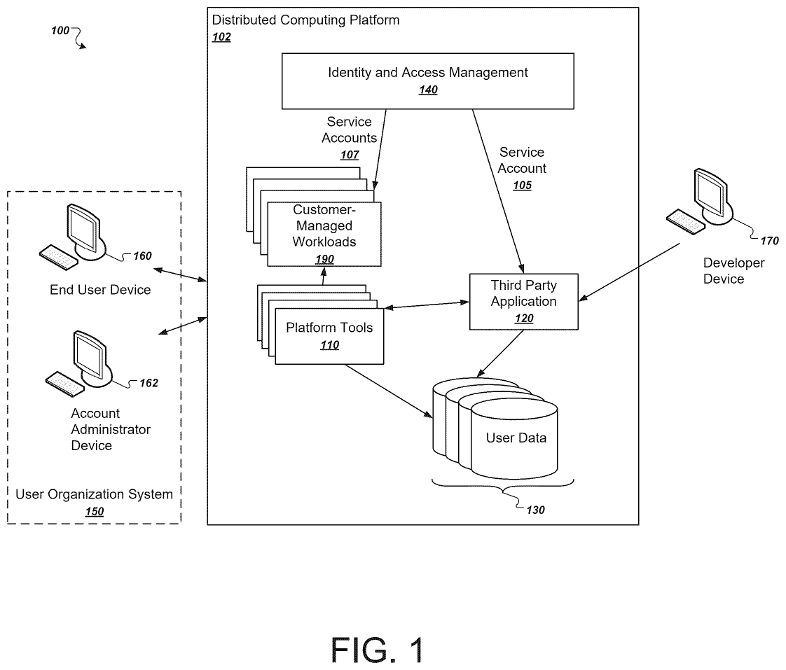

FIG. 1 is a diagram of an example system 100. The system includes a distributed computing platform 102 in communication with devices belonging to a user organization system 150 and a developer device 170. The system 100 is an example of a system that can implement the service account techniques described in this specification.

The user organization system 150 in this example illustrates a typical scenario in which a group of affiliated users have an organization account on the distributed computing platform 102 that provides access to one or more platform tools 110. For example, the user organization can be a company, an association, a university, or any other appropriate group of affiliated users that share an organization account on the platform 102.

In this example, the user organization system 150 includes an end user device 160 and an account administrator device 162. The account administrative device 162 is associated with an account administrator, whose user account has privileges on the distributed computing platform 102 to manage and configure permissions, other user accounts, and other settings on the distributed computing platform 102. The end user device 160 is a device associated with an end user of the one or more platform tools 110. In operation, an account administrator can use the account administrator device 162 to set up user accounts for all of the end users of the user organization system 150. These are the end users who are expected to have access to the one or more platform tools 110.

The distributed computing platform 102 is a distributed computing system that includes tens, hundreds, or thousands of physical computing nodes. A distributed computing platform is typically hosted in one or more datacenters in which the computing nodes are networked together by internal networks or the Internet. The entity that provides the distributed computing platform need not own or operate the underlying datacenter hardware. Rather, the distributed computing platform can be provided as a software service running on the datacenter hardware. However, in some implementations, all computing nodes can be owned and operated by the entity that provides the distributed computing platform.

The distributed computing platform 102 hosts one or more platform tools 110 accessible by one or more end users, for example, a user of the end user device 160. One example of a platform tool 110 on the distributed computing platform 102 is a cloud-based computer aided design (CAD) system that allows users to access various CAD programs. Another example of platform tools 110 on the distributed computing platform 102 is software implementing a rendering farm that allows users to distribute rendering tasks to hundreds or thousands of underlying computing nodes.

The distributed computing platform 102 stores collections of user data 130. The collections of user data 130 are provided by or developed by administrators or end users of the platform 102, for example, users belonging to a user organization, e.g., end users or account administrators of the user organization system 150. For example, an architecture firm can store building designs and associated metadata in a database or a file system represented by one or more collections of user data 130. The collections of user data 130 are generally partitioned into different segments having different access controls. Therefore, the platform 102 can enforce access controls based on who was providing the request.

In some implementations, the distributed computing platform 102 maintains a customer relationship with one or more organizations. Each customer relationship can be represented by an entity called a team having one or more users. The team is thus associated with a customer arrangement with the distributed computing platform 102, e.g., a subscription. Customer team administrators can thus manage user accounts and service accounts for the organization.

The distributed computing platform 102 also includes an identity and access management subsystem 140, which is a software subsystem that can control the lifecycle of accounts on the distributed computing platform 102 as well as manage access controls to user data 130 by accounts on the platform 102. In this example, the identity management and access management functions are illustrated as being performed by the same subsystem, but these functions can also be performed by different subsystems.

The distributed computing platform 102 also includes functionality for hosting third-party applications. In general, a third-party application is a software subsystem that was created by a developer. The developer who writes an application that is used in a distributed computing platform by users of a user organization is typically not a part of the user organization itself, but in some cases could also be a part of the user organization. In other words, the developers are typically third parties relative to users of the platform and the entity that provides the platform itself.

The developer can use a developer device 170 to provide data for running a third-party application 120 on the distributed computing platform 102. This functionality allows the one or more platform tools 110 to communicate with the third party application 120 to make use of its functionalities or services. For example, the distributed computing platform 102 can provide a developer portal that provides a user interface into the platform 102 for creating, developing, and uploading applications.

In order to enhance data security and simplify the administration of third-party applications, the distributed computing platform can assign service accounts to third-party applications. For example, when a developer uploads the third-party application 120 to the distributed computing platform 102, the identity and access management system 140 can create and assign a service account 105 to the third-party application. In this arrangement, the developer still has control over the service account 105 created for the third-party application and can manage or modify the service account 105.

The account administrator of the user organization system 150 can then configure access policies for service account 105 assigned to the third party application 120. The access policies specify which of the platform tools 110, the collections of user data 130, or some combination of these, that the third-party application 120 is allowed to use when making access requests on behalf of its assigned service account 105. For example, the account administrator can specify that the service account 105 assigned to the third-party application 120 can only access one collection of user data 130. This, for example, can represent an account administrator of an architecture firm limiting the access of a cost estimation application to only one project out of hundreds of projects owned in the distributed computing platform 102 by the architecture firm.

The third-party application can then make requests throughout the distributed computing platform using access credentials of the service account, and the distributed computing platform 102 will enforce the access requests according to the access policies configured by the account administrators. For example, the third-party application 120 can make requests to access the collections of user data 130 using the access credentials of a service account. As part of this process, the identity and access management system 140 can use public key/private key pairs generated at the time the service account was created in order to grant (or deny granting) access tokens to third-party applications. This mechanism is described in more detail below.

Service accounts can also be used for non-human entities that are set up and controlled by users of the platform 102, e.g., users of the user organization system 150 or users belonging to a customer team. For example, the customer team administrator can initialize a plurality of workloads 190 on respective computing nodes, which can then be referred to as customer-managed workloads. The customer-managed workloads 190 can be initialized in the distributed computing platform 102 itself or on another distributed computing platform. In other words, the entity that manages the service accounts through the identity and access management subsystem 140 need not be the same entity that owns and controls the platform running the customer-managed workloads 190. One example of user workloads 190 are computing tasks to implement a rendering farm in order to take input graphics data and to generate the individual frames of a video in parallel.

The account administrator can provide a request to the identity and access management subsystem 140 to generate service accounts 107 for the customer-managed workloads 190. The identity and access management subsystem 140 can then provide each of the customer-managed workloads 190 with access credentials according to the assigned service accounts 107. And because the initialization process uses messages signed with private keys without relying on human logins with a username and password, deploying the user workloads 190 in the distributed computing platform 102 is much easier and much faster.

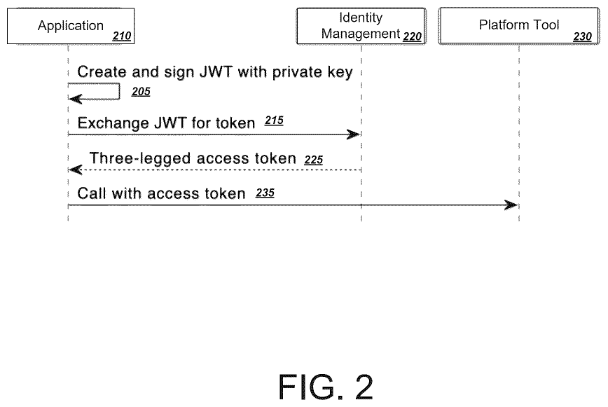

FIG. 2 is a diagram illustrating issuing an access token to an application 210 having a service account. In this example, the application 210 can be a third-party application as described above or a user-deployed application on a distributed computing platform.

In this example, a service account has been assigned to the application 210 by the identity management subsystem 220. The application 210 now has access to the service account identifier (id) for the service account.

The application 210 can then obtain or generate public and private keys for the service account using any appropriate asymmetric cryptography process. Asymmetric cryptography, also known as public-key cryptography, uses a pair of keys: a public key and a private key. These keys are mathematically related in a way that it is fast to verify their relationship but computationally infeasible to derive the private key from the public key. The public key can be freely distributed, while the private key must be kept secret. The public key is used to encrypt data or verify digital signatures. The private key is used to decrypt data or create signatures. These techniques allow secure communication and authentication without needing to share secret keys.

In some implementations, the cloud computing platform can make a software-development kit (SDK) available for application developers to incorporate into their applications so that the applications know how to generate appropriate public and private keys for use with a service account. The cloud computing platform may store the private key in a secure custom key store, ensuring the key is non-extractable and significantly reducing the risk of key compromise. In some other implementations, the application can download the public and private keys from the identity management subsystem 220. In such cases, the Identity Management System ensures that the private key can only be downloaded once and is not stored thereafter, thereby mitigating the risk of leakage. Furthermore, the Identity Management System supports key rotation and expiration for enhanced security.

The public key for the service account can be stored by the identity management subsystem 220, while the private key can remain securely stored on the machine or device running the application 210.

At step 205, the application creates a signed message with its private key. In some implementations, the signed message has the form of a JSON Web Token (JWT). In asymmetric cryptography systems, a message signed with a private key can be verified using the public key stored by the identity management subsystem 220.

A step 215, the application provides to the identity management subsystem 220 the signed message as part of a request for an access token. The identity management subsystem 220 can then use the public key for the associated service account to verify the authenticity of the signed message. If the authenticity of the signed message cannot be verified, the identity management subsystem 220 can decline to issue an access token and can instead respond with an error message.

If the signed message is verified, at step 225 the identity management subsystem 220 provides an access token to the application 210. The application 210 can then include the access token in requests to various tools and software systems on the platform.

For example, at step 235, the application can provide a call with the access token to a platform tool 230. The platform tool 230 can then use the access token to perform the usual checks on access control as it would for any other human user.

The process illustrated in FIG. 2 is typically different from the process of issuing access tokens to applications being controlled by human users. In those scenarios, the human users log in by providing a username and password to the identity management subsystem 220, and the identity management subsystem 220 can issue an access token in response.

This example illustrates that by generating the public and private key pairs, a non-human entity, e.g., the application 210 that has been assigned a service account can be initialized to access platform tools and services without the need for human intervention or control, and without using a username and password.

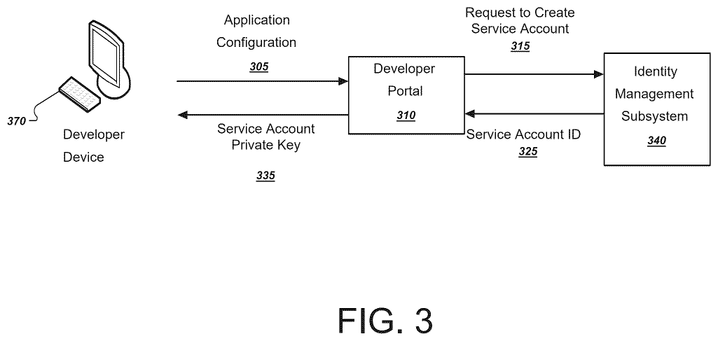

FIG. 3 illustrates assigning an application-managed service account to an application. In this example, a developer of a third-party application can use a developer device 370 to access a developer portal 310 of the platform and to configure an application 305. The developer portal is a software subsystem that provides functionality for developers to create and configure their third-party applications. This can include setting up API access, defining scopes, and managing other integration-related settings. Generally, the assets, code, and core functionality of the third-party applications are managed outside of the platform. Once an application is developed and properly configured, a developer can publish the application on the platform, e.g., in an app-store-like marketplace.

The developer portal 310, upon receiving an application configuration 305, provides a request to create a service account 315 to an identity management subsystem 340. The identity management subsystem 340 generates the service account, which can include assigning a service account id, and optionally, an email address.

The identity management subsystem 340 provides the service account id 325 to the developer portal 310. The developer portal 310 can then generate a public key/private key pair for the service account and can provide the service account private key 335 back to the developer device 370.

The developer and platform administrators can then use the service account to control access by the application to platform tools and user data, which can include managing API permissions, implementing application-level security, and monitoring usage.

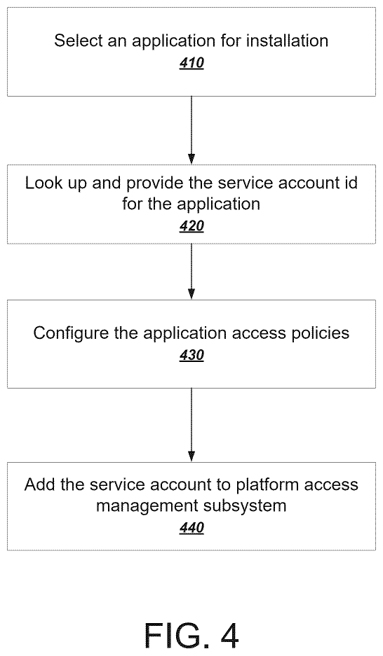

FIG. 4 is a flowchart illustrating an account administrator installing a third-party application having a service account. In this example, the account administrator is a user account that has privileges to install third-party applications for use by one or more platform tools of a platform instance. The account administrator therefore generally has more privileges than an ordinary user account that is authorized to access the one or more platform tools.

At step 410, the account administrator selects an application for installation. In some implementations, the platform can provide a gallery of applications that are available to be installed for certain platform tools. Using the example described above, for platform tools that relate to CAD design of buildings, an app gallery can list applications that relate to cost estimation or applications that perform other auxiliary functions. In some implementations, the platform can make available for selection only those third-party applications that have been assigned respective service accounts.

At step 420, upon receiving the selection, the platform looks up and provides the service account id assigned to the application. As described above, when a developer submits an application to the platform, the platform can create a service account with an associated service account id.

At step 430, the account administrator configures the application access policies for a platform instance. As described above, an instance of one or more platform tools has associated access policies that dictate which users can access which portions of data generated or maintained by the platform tools of the instance. The account administrator can configure the access controls for the application service account in order to specify which portions of the underlying data the application is allowed to access.

At step 440, the configured service account is added to an access management subsystem. As described above, the access management subsystem can control access to various portions of tools or data on the platform. Adding the configuration for the service account to the access control system will allow the service account to use an access token to access tools or data as configured by the account administrator.

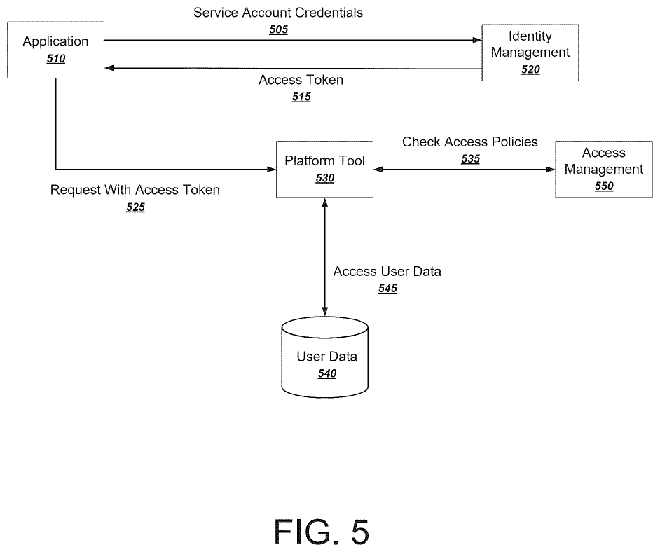

FIG. 5 illustrates a run-time example of an application having a service account accessing project data. In this example, the application 510 has an associated service account with the identity management subsystem 520.

At step 505, the application provides credentials to the identity management subsystem. As described above, this can include a signed message that is signed with the service account private key.

At step 515, the identity management subsystem 520 authenticates the service account using the service account public key and provides an access token back to the application 510.

At step 525, the application 510 provides a request along with the granted access token to a platform tool 530. For example, the application 510 can send a request to an API of a cloud-based CAD system. The request will specify a system resource that the application is requesting to access. Such system resources can include files, folders, projects, drives, computing nodes, or any other appropriate partition of data in the platform.

At step 535, the platform tool 530 checks with the access management subsystem 550 to determine whether the service account for the application 510 has been configured with the proper credentials for accessing the requested resource.

At step 545, if access for the service account has been verified, the platform tool 530 accesses the user data 540 on behalf of the associated application 510.

On the other hand, if access is not permitted based on the configuration of the service account, the platform tool 530 can deny the request and provide a notification to the application. As one example, a building design firm can have multiple construction projects stored under an instance of the platform. The access policies for the service account can specify which files of which construction projects the application 510 is permitted to access. And the platform tool 530 can enforce such access restrictions based on the configuration of the service account.

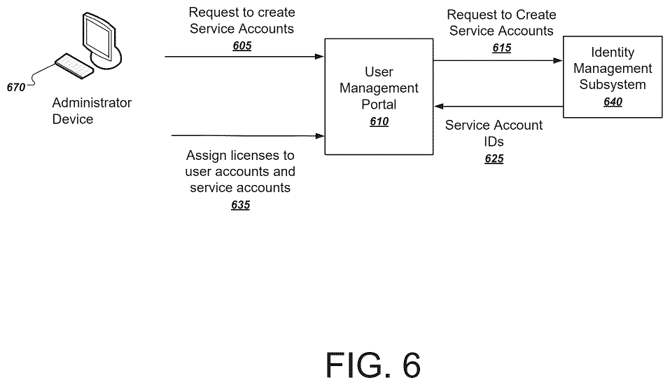

FIG. 6 illustrates creating customer-managed service accounts. As described above, service accounts can also be used for other situations that use non-human entities besides third-party applications. As one example, an account administrator can create service accounts for the purpose of scaling up the deployment of computing workloads. Because the service accounts can be initialized without human involvement, e.g., using private keys to receive an access token, the process is much more scalable than prior approaches that require usernames and passwords. In addition, using service accounts can greatly simplify the administrative overhead of issuing and keeping track of licenses. Rather, the system can simply keep track, with a licensing subsystem 850 running within the distributed computing platform, of which service accounts are assigned to which licenses.

This approach avoids the traditional need to install and run a license server on the customer's premises. The license server running on the customer's premises acts as an intermediary by providing licenses to software running on the customer's premises and recording usage metrics for reconciliation by the distributed computing platform. This approach increases maintenance overhead and the risk of a service disruption if the license server goes down.

All of these downsides with customer-centric license servers are vastly mitigated by using service accounts for customer-managed workloads.

In this example, a user management portal 610 is a software subsystem that provides an interface to an administrator device 670. The administrator device 670 is a device of a user who has privileges to allocate and configure resources within an organization account or within a customer team on the platform. For example, the administrator can set up user accounts for members of an engineering team of an organization.

The administrator can also set up customer-managed service accounts for the computing workloads. The administrator device 670 can thus provide a request to create service accounts 605 to the user management portal 610. The request can for example specify a number of service accounts to be created.

The user management portal 610 can then forward the request 615 to the identity management subsystem 640. The identity management subsystem 640 can then create the specific number of customer-managed service accounts 640 and add the service accounts to the team or organization account. The organization or team account now has a number of ordinary user accounts and a number of service accounts.

At step 635, using the user management portal 610, the administrator can assign software licenses, or software license seats, to some combination of the user accounts and to the service accounts. In this way, the process of assigning seats is no longer different from user accounts versus service accounts.

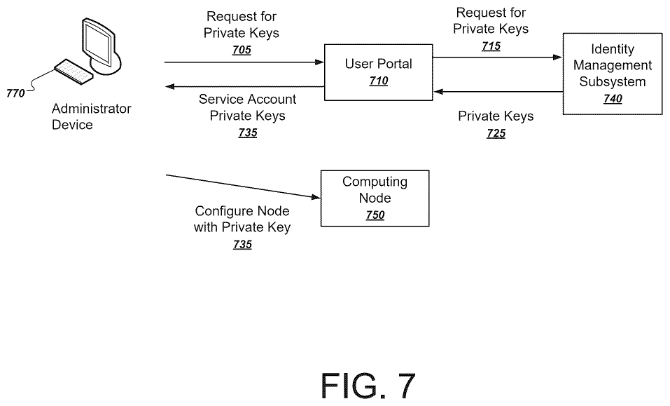

FIG. 7 illustrates attaching customer-managed service accounts to computing nodes. Because access credentials for service accounts can be based on private keys, associating a computing node with a service account can involve configuring the computing node to have access to the private key for the service account.

At step 705, the administrator device provides a request through the user management portal 710 for private keys for a service account. At step 715, the user management portal 710 forwards the request to the identity management subsystem 740. At step 725, The identity management subsystem 740 responds by providing the private keys of the requested service accounts, which are then forwarded to the administrator device 770.

At step 735, the administrator device 770 configures a computing node 750 to have the private key. In some implementations, the administrator device installs an SDK on the computing node that provides the functionality for using the private key to obtain access tokens from the identity management subsystem 740.

The computing node 750 can now use the private key to obtain access tokens and can function as if it were a normal human user, using the same APIs throughout the system as human users would.

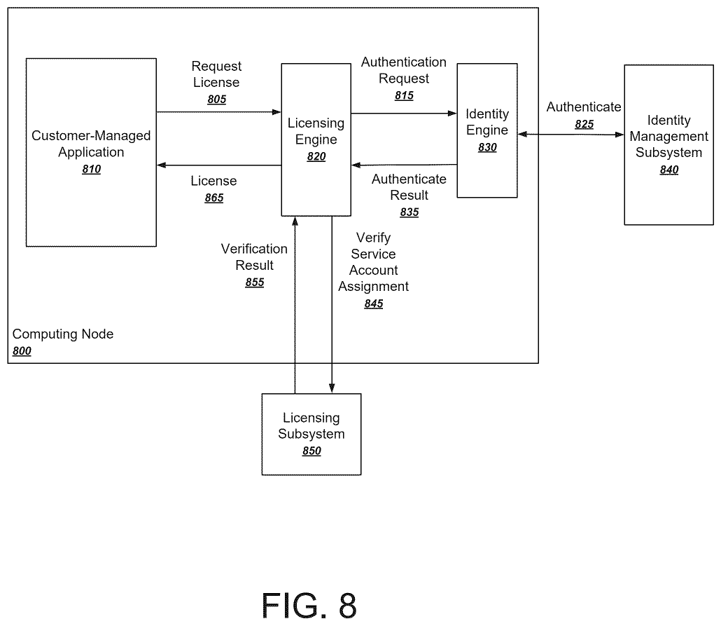

FIG. 8 illustrates how service accounts can be used to manage licenses for non-human entities in a distributed computing platform. In this example, a computing node 800 is running a customer-managed application 810. The customer-managed application can be a computing workload that is part of hundreds of similar computing workloads running on the distributed computing platform.

The customer-managed application 810 requires a software license in order to execute some or all of its functionality. In order to manage such licenses, the computing node 800 makes use of a licensing engine 820, which is a software subsystem or SDK that provides the functionality to interface with a licensing subsystem 840. The licensing subsystem 840 is a software subsystem that maintains information about which licenses have been assigned to which accounts on the platform. In some implementations, licenses can be assigned equally to user accounts or to service accounts.

Thus, at step 805, the customer-managed application 810 provides a request for a license to the licensing engine 820. The licensing engine 820 will then seek to authenticate the service account assigned to the computing node 800.

At step 815, the licensing engine 820 provides an authentication request to the identity engine 830. The identity engine 830 is a software subsystem or SDK that provides the functionality to interface with the identity management subsystem 840 in order to authenticate a service account and to obtain access credentials for a non-human entity to which the service account is assigned.

At step 825, the identity engine 830 performs an authentication process with the identity management subsystem 840. As described above, this can involve obtaining a private key for the service account stored on the computing node and providing a signed message to the identity management subsystem 840 that was signed with the private key. In response, the identity management subsystem 840 can provide access credentials that verify that the service account is authenticated.

At step 835, the identity engine 830 provides the authentication result 835 back to the licensing engine 820. The licensing engine 820 can examine the authentication result, e.g., the access credentials provided by the identity management subsystem 840.

If the service account for the computing node 800 is authenticated, the licensing engine 820 can check to see whether the corresponding service account has been assigned a license. To do so, at step 845, the licensing engine 820 provides a request to verify the service account assignment to the licensing subsystem 850.

At step 855, the licensing subsystem 850 responds with a verification result that indicates whether or not the service account has been assigned a license. As part of this process, the licensing subsystem can itself assign a new license to the service account.

At step 865, if the service account is verified to have a license, the licensing engine 820 provides the license to the customer-managed application 810. The customer-managed application 810 has now been provided the capability to perform its functionality that required the license.

As this example illustrates, the use of service accounts provides for seamless identity management for machines, nodes, and devices, which allows them to be recognized as distinct entities within the system.

As the above description has shown, service accounts eliminate human interaction in authentication while still being managed as user accounts, enabling fine-grained access control on the platform or used for other purpose like removing need for complicated machine based licensing. These techniques therefore broadly facilitate various software workflows required by the distributed computing platform and its customers and users. This approach is applicable in diverse scenarios such as managing large IoT device fleets, executing large-scale simulations or computational jobs, and enabling bots to complete business workflows. In all these cases, service accounts provide a secure, scalable, and efficient method of authentication and authorization, streamlining operations that would otherwise require manual intervention or less secure practices.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program which may also be referred to or described as a program, software, a software application, an app, a module, a software module, a script, or code) can be written in any form of programming language, including compiled or interpreted languages, or declarative or procedural languages, and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

As used in this specification, an “engine,” or “software engine,” refers to a software implemented input/output system that provides an output that is different from the input. An engine can be an encoded block of functionality, such as a library, a platform, a software development kit (“SDK”), or an object. Each engine can be implemented on any appropriate type of computing device, e.g., servers, mobile phones, tablet computers, notebook computers, music players, e-book readers, laptop or desktop computers, PDAs, smart phones, or other stationary or portable devices, that includes one or more processors and computer readable media. Additionally, two or more of the engines may be implemented on the same computing device, or on different computing devices.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and pointing device, e.g., a mouse, trackball, or a presence sensitive display or other surface by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone, running a messaging application, and receiving responsive messages from the user in return.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network.

The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

In addition to the embodiments described above, the following embodiments are also innovative:

Embodiment 1 is a distributed computing platform comprising a plurality of computers configured to execute instructions implementing a plurality of software subsystems, wherein the plurality of software subsystems comprise:
an identity management subsystem, and
one or more platform tools,
wherein the identity management subsystem is configured to maintain user accounts for human users to access the one or more platform tools, and
wherein the identity management subsystem is configured to maintain service accounts for non-human entities in the platform and to provide access tokens for authenticated non-human entities based on service account credentials.

Embodiment 2 is the distributed computing platform of embodiment 1, wherein the user accounts and the service accounts use the same type of access credentials.

Embodiment 3 is the distributed computing platform of any one of embodiments 1-2, wherein the user accounts and the service accounts use different authentication processes.

Embodiment 4 is the distributed computing platform of embodiment 3, wherein the service accounts are authenticated using messages signed with private keys.

Embodiment 5 is the distributed computing platform of embodiment 4, wherein the user accounts are authenticated using logins requiring usernames and passwords.

Embodiment 6 is the distributed computing platform of embodiment 5, wherein the user accounts and the service accounts have the same access policy controls.

Embodiment 7 is the distributed computing platform of any one of embodiments 1-6, wherein the non-human entity is a third-party application provided by a developer and usable by the one or more platform tools.

Embodiment 8 is the distributed computing platform of embodiment 7, wherein the identity management subsystem is configured to assign a service account to the third-party application after the third-party application is configured by the developer.

Embodiment 9 is the distributed computing platform of embodiment 8, wherein the developer maintains the service account assigned to the third-party application.

Embodiment 10 is the distributed computing platform of any one of embodiments 1-9, wherein the non-human entity is a customer-managed workload installed on a computing node by an account administrator.

Embodiment 11 is the distributed computing platform of embodiment 10, wherein the computing node is configured with a private key of a service account, and wherein the customer-managed workload is configured to obtain access credentials using the private key of the computing node.

Embodiment 12 is the distributed computing platform of any one of embodiments 1-11, further comprising a licensing subsystem, wherein the licensing subsystem is configured to assign a pool of licenses to both user accounts and service accounts.

Embodiment 13 is a method comprising:
maintaining, by an identity management subsystem of a distributed computing platform comprising a plurality of computers, a plurality of user accounts for human users and a plurality of service accounts for non-human entities;
receiving, by the identity management subsystem, a signed message from a non-human entity in the distributed computing platform;
determining that a service account assigned to the non-human entity is authenticated based on the signed message; and
in response, providing an access token to the non-human entity.

Embodiment 14 is method of embodiment 13, further comprising:
receiving, by a platform tool hosted by the distributed computing platform, a request from the non-human entity assigned the service account, wherein the request includes the access token issued by the identity management subsystem;
obtaining one or more access control policies associated with the service account corresponding to the access token; and
providing access to data on the platform in accordance with the one or more access control policies associated with the service account.

Embodiment 15 is the method of any one of embodiments 13-14, wherein the user accounts and the service accounts use the same type of access credentials.

Embodiment 16 is the method of any one of embodiments 13-15, wherein the user accounts and the service accounts use different authentication processes.

Embodiment 17 is the method of embodiment 16, wherein the service accounts are authenticated using messages signed with private keys.

Embodiment 18 is the method of embodiment 17, wherein the user accounts are authenticated using logins requiring usernames and passwords.

Embodiment 19 is the method of embodiment 18, wherein the user accounts and the service accounts have the same access policy controls.

Embodiment 20 is the method of any one of embodiments 13-19, wherein the non-human entity is a third-party application provided by a developer and usable by the one or more platform tools.

Embodiment 21 is the method of embodiment 20, wherein the identity management subsystem is configured to assign a service account to the third-party application after the third-party application is configured by received from the developer.

Embodiment 22 is the method of any one of embodiments 13-21, wherein the non-human entity is a customer-managed workload installed on a computing node by an account administrator.

Embodiment 23 is a system comprising: one or more computers and one or more storage devices storing instructions that are operable, when executed by the one or more computers, to cause the one or more computers to perform the method of any one of embodiments 13 to 22.

Embodiment 24 is a computer storage medium encoded with a computer program, the program comprising instructions that are operable, when executed by data processing apparatus, to cause the data processing apparatus to perform the method of any one of embodiments 13 to 22.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A distributed computing platform comprising a plurality of computers configured to execute instructions implementing a plurality of software subsystems, wherein the plurality of software subsystems comprise:
an identity management subsystem, and
one or more platform tools,
wherein the identity management subsystem is configured to maintain user accounts for human users to access the one or more platform tools, and
wherein the identity management subsystem is configured to maintain service accounts for non-human entities in the platform and to provide access tokens for authenticated non-human entities based on service account credentials.

2. The distributed computing platform of claim 1, wherein the user accounts and the service accounts use the same type of access credentials.

3. The distributed computing platform of claim 1, wherein the user accounts and the service accounts use different authentication processes.

4. The distributed computing platform of claim 3, wherein the service accounts are authenticated using messages signed with private keys.

5. The distributed computing platform of claim 4, wherein the user accounts are authenticated using logins requiring usernames and passwords.

6. The distributed computing platform of claim 5, wherein the user accounts and the service accounts have the same access policy controls.

7. The distributed computing platform of claim 1, wherein the non-human entity is a third-party application provided by a developer and usable by the one or more platform tools.

8. The distributed computing platform of claim 7, wherein the identity management subsystem is configured to assign a service account to the third-party application after the third-party application is configured by the developer.

9. The distributed computing platform of claim 8, wherein the developer maintains the service account assigned to the third-party application.

10. The distributed computing platform of claim 1, wherein the non-human entity is a customer-managed workload installed on a computing node by an account administrator.

11. The distributed computing platform of claim 10, wherein the computing node is configured with a private key of a service account, and wherein the customer-managed workload is configured to obtain access credentials using the private key of the computing node.

12. The distributed computing platform of claim 1, further comprising a licensing subsystem, wherein the licensing subsystem is configured to assign a pool of licenses to both user accounts and service accounts.

13. A computer-implemented method comprising:
maintaining, by an identity management subsystem of a distributed computing platform comprising a plurality of computers, a plurality of user accounts for human users and a plurality of service accounts for non-human entities;
receiving, by the identity management subsystem, a signed message from a non-human entity in the distributed computing platform;
determining that a service account assigned to the non-human entity is authenticated based on the signed message; and
in response, providing an access token to the non-human entity.

14. The method of claim 13, further comprising:
receiving, by a platform tool hosted by the distributed computing platform, a request from the non-human entity assigned the service account, wherein the request includes the access token issued by the identity management subsystem;
obtaining one or more access control policies associated with the service account corresponding to the access token; and
providing access to data on the platform in accordance with the one or more access control policies associated with the service account.

15. The method of claim 13, wherein the user accounts and the service accounts use the same type of access credentials.

16. The method of claim 1, wherein the user accounts and the service accounts use different authentication processes.

17. The method of claim 16, wherein the service accounts are authenticated using messages signed with private keys.

18. The method of claim 17, wherein the user accounts are authenticated using logins requiring usernames and passwords.

19. The method of claim 18, wherein the user accounts and the service accounts have the same access policy controls.

20. The method of claim 13, wherein the non-human entity is a third-party application provided by a developer and usable by the one or more platform tools.

21. The method of claim 20, wherein the identity management subsystem is configured to assign a service account to the third-party application after the third-party application is configured by received from the developer.

22. The method of claim 13, wherein the non-human entity is a customer-managed workload installed on a computing node by an account administrator.
